(19) United States
(12) Patent Application Publication
(10) Pub. No.: US 2009/0016579 A1
(43) Pub. Date: Jan. 15, 2009

(54) Method and system for performing quality control of medical images in a clinical trial

(75) Inventors: David L. White, Oakland, CA (US); Gregg Tedeski, San Francisco, CA (US); Jener Asino Basilio, San Francisco, CA (US); Douglas Alan Ortendahl, San Francisco, CA (US); Vahan E. Sharoyan, Lafayette, CA (US); Gregory Alan Erickson, San Francisco, CA (US)

Correspondence Address: K&L Gates LLP, STATE STREET FINANCIAL CENTER, One Lincoln Street, BOSTON, MA, 02111-2950, US

(73) Assignee: Synarc, Inc., San Francisco, CA (US)

(21) Appl. No.: 11/825,734

(22) Filed: Jul. 9, 2007

(51) Int. Cl. G06K 9/00

(52) U.S. Cl. 382/128

(57) ABSTRACT

A method for performing quality control on medical images in a clinical trial setting. In one embodiment, the method includes the steps of designating an image as reference image; obtaining attribute data from the reference image as reference attribute data; storing the reference image and the reference attribute data; subsequently taking a second image; obtaining attribute data from the second image as second attribute data; comparing the second image with the reference image on a single output screen; and denoting on the single output screen the second attribute data associated with the second image which differs from the reference data associated with the reference image.

### FIELD OF THE INVENTION

The field of the invention generally is medical imaging and, more specifically, quality control of medical imaging by comparing attributes associated with medical images with predetermined references.

### BACKGROUND FOR THE INVENTION

Medical images such as x-ray radiographs, Computed Tomography (“CT”) radiographs, Positron Emission Tomography (“PET”) images, magnetic resonance images (“MRI”) are essential tools for diagnosing diseases, monitoring disease progressions or remissions, and directing treatments. The medical decisions derived based upon these images are vitally important for the individual patients and the health care system as a whole. To be confident about making these important decisions, radiologists and other medical professionals must have adequate assurance that the images were appropriately acquired.

In clinical trials, it is even more critical to maintain at a high level the quality of medical images to assure the accuracy and validity of the test data derived from these images. The results of clinical trials not only may have an impact on individual patient care, but also on far reaching decisions about the efficacy and safety of drugs, devices, and/or treatment methods. In a clinical trial setting, images are typically obtained at multiple clinical sites, each with its own particular combination of technicians, procedural protocols and equipment. The experience of the technicians, the customization of each protocol, and the models of the equipment used may significantly vary from one site to another. Additionally, many of these trials take place over periods of time ranging from weeks to years, during which changes of personnel and equipment often occur. To obtain valid and meaningful results of a trial, it is essential that image acquisitions at all clinical sites during the entire course of the trial adhere to a pre-determined protocol and set of specifications to produce comparable and compatible data for analysis.

Thus, what is needed is a method of providing quality control of medical images in a clinical trial context.

### SUMMARY OF THE INVENTION

The invention relates generally to a method and system for providing a quality control of medical images in a clinical trial context by comparing attribute data of an image with pre-defined reference attribute data.

In one aspect, the invention relates to a method for performing quality control on medical images in a clinical trial setting. In one embodiment, the method includes the steps of designating an image as reference image; obtaining attribute data from the reference image as reference attribute data; storing the reference image and the reference attribute data; subsequently taking a second image; obtaining attribute data from the second image as second attribute data; comparing the second image with the reference image on a single output screen; and denoting on the single output screen the second attribute data associated with the second image which differs from the reference data associated with the reference image. In another embodiment, the reference image and the reference attribute data are stored in a single electronic file. In another embodiment, the second image and the second attribute data are stored in a single electronic file. In yet another embodiment, the second image is taken from a set of medical images.

In another aspect, a method for comparing a first medical image and a second medical image in a clinical trial setting is provided. In one embodiment, the method includes the steps of obtaining a first set of attributes from the first medical image; obtaining the second set of attributes from the second medical image; and displaying the first and second sets of attributes on a single output screen. In another embodiment, the method further comprises the steps of comparing the first set of attributes with the second set of attributes; and denoting attributes from the second set of attributes which differs from any attributes of the first set of attributes.

In another embodiment, the method further comprises the step of displaying on a display the attribute from the second set of attributes which differs from a corresponding attribute in the first set of attributes. In yet another embodiment, the comparing step further comprises the step of displaying on a display the first medical image with the first set of attributes and the second image with the second set of attributes. In yet another embodiment, the step of denoting further comprises highlighting the attributes from the second set of attributes which differ from corresponding attributes in the first set of attributes. In yet another embodiment, the first set of attributes is displayed as an annotation upon the first medical image and the second set of attributes is displayed as an annotation upon the second medical image.

In yet another aspect, a method for performing quality control on a medical image in a clinical trial is provided. In one embodiment, the method includes the steps of defining a reference set of attributes, each reference attribute having a predetermined range of valid values; obtaining a first set of attributes associated with the medical image; obtaining the value of each attribute in the first set of attributes; comparing each attribute of the first set of attributes with a corresponding attribute of the reference set of attributes; and denoting attributes of the first set of attributes having a value outside of the valid range of values assigned to a corresponding attribute in the reference set of attributes.

In yet another aspect, a system for performing quality control on medical images in a clinical trial setting is provided. In one embodiment, the system includes a first input device for designating an image as reference image; a second input device for obtaining attribute data from the reference image as reference attribute date; data storage device for storing the reference image and the reference attribute data; an imaging device for subsequently taking a second image; a third input device for obtaining second attribute data from the second image; a single display for comparing the second image with the reference image; and a display indicator for denoting an attribute from the second attribute data associated with the second image which differs from a corresponding attribute from the reference data associated with the reference image.

### BRIEF DESCRIPTION OF THE DRAWINGS

The foregoing and other objects, aspects, features, and advantages of the invention will become more apparent and may be better understood by referring to the following description taken in conjunction with the accompanying drawings, in which:

FIG. 1 is a diagram illustrating a set of medical images, each stored in an electronic file format, in accordance with an embodiment of the invention;

FIG. 2 is a flow chart illustrating the steps of performing quality control of a medical image, according to an embodiment of the invention;

FIG. 3 is a diagram illustrating a display layout for comparing a medical image with a reference image, according to an embodiment of the invention;

FIG. 4 is a screen shot illustrating a side-by-side display of exemplary attributes associated with a reference image and a test image, according to an embodiment of the invention;

FIG. 5 is another screen shot illustrating a side-by-side display of exemplary attributes associated with a reference image and a test image, according to an embodiment of the invention; and

FIG. 6 is yet another screen shot illustrating an exemplary display of attributes.

### DETAILED DESCRIPTION OF THE PREFERRED EMBODIMENTS

The present invention will be more completely understood through the following detailed description, which should be read in conjunction with the attached drawings. In this description, like numbers refer to similar elements within various embodiments of the present invention. Within this detailed description, the claimed invention will be explained with respect to preferred embodiments. However, the skilled artisan will readily appreciate that the methods and systems described herein are merely exemplary and that variations can be made without departing from the spirit and scope of the invention.

The quality and diagnostic value of medical images are influenced to a large degree by the methods, machine settings, and parameters used in the acquisitions of the images. Conventional x-ray radiography is relatively straightforward in this regard, as the image is essentially a shadow projected onto a piece of photographic film. Exposure time, and x-ray tube voltage and current are the major determinants of image contrast. However, more recently developed techniques such as digital x-ray (where the photographic film is replaced by an array of detectors), CT, PET, and MRI are inherently more complex due to the underlying physics of the modalities themselves and the fact that the images are digital. That is, detector responses, typically measured in voltage or current, are processed by a mathematical algorithm to calculate and reconstruct the images. In these complex systems there can be over a hundred individual settings that have a greater or lesser impact on the resulting images. For such images, acquisition attributes typically are automatically stored by the imaging device along with the pixel data in an electronic file.

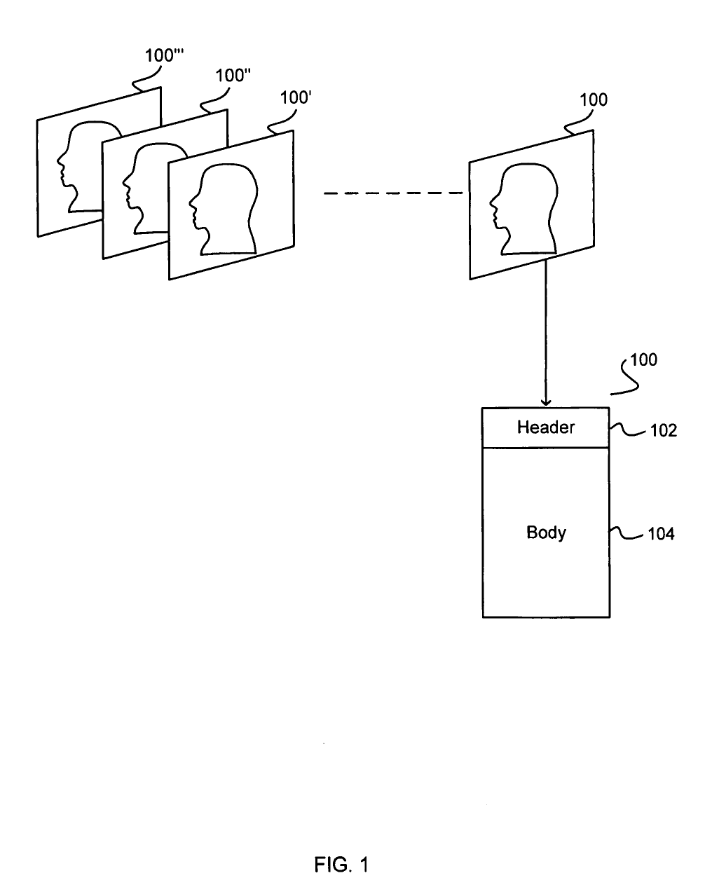

An example of such an electronic file 100 of a medical image is illustrated in FIG. 1. In one embodiment of the invention, the electronic file typically includes a header 102 and a body 104. The header 102 portion is allocated for storing the various attributes of the image and the body 104 contains pixel data of the image itself which can later be extracted for display. In another embodiment, a set of medical images is taken as a part of a clinical trial. The set of images further includes one or more series of medical images, for example, a temporal series or a spatial series. As shown in FIG. 1, when a series of medical images is being studied, the images in the series are stored in an array of electronic files 100′, 100″, 100′″, each file with the same header-body format. The same is true where the series of images are spatial variations of the same object such as in tomographic or MRI slices. In other embodiments, the format of the electronic file may be a proprietary one defined by the manufacturer of the scanner and/or camera used to capture the images, or it may conform to a common, universal standard such as the Digital Imaging and Communication in Medicine standard (“DICOM”). In any case, full evaluation of the image requires not only visual assessment by an experience medical doctor or technician, but also an examination of the attributes associated with the acquired image.

The present invention discloses methods and systems for providing quality control of medical images in a clinical trial by comparing attribute data of an image with predefined reference attribute data. Specifically, embodiments of the invention utilize a visual display on a computer that highlights the similarities and/or differences between a desired set of image attributes and reference set of attribute. As such, the methods and systems of the invention have the advantage of allowing an image reader to quickly and accurately ascertain whether an image meets certain specifications.

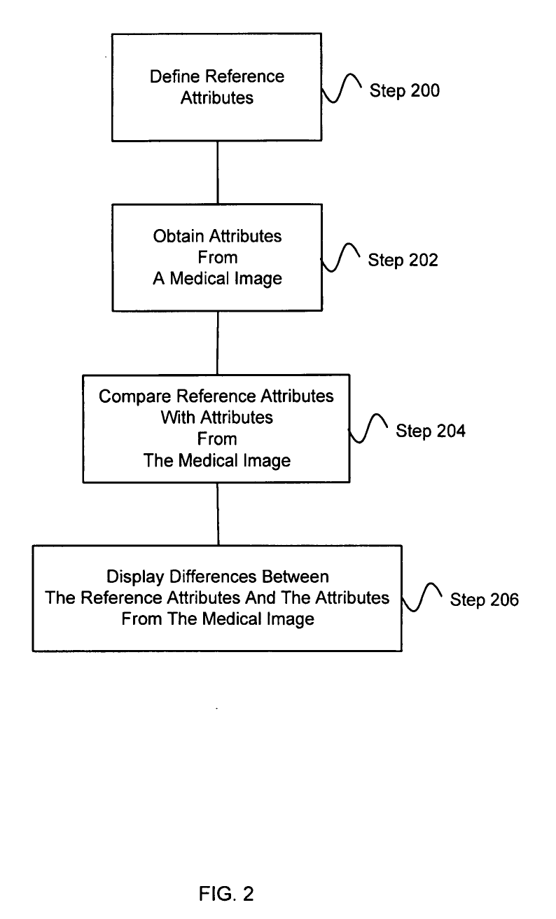

The flow chart of FIG. 2 illustrates the basic steps of performing quality control of a medical image, according to an embodiment of the invention. Referring to FIG. 2, a set of reference attributes is first defined as the baseline for quality control (step 200). The attributes preferably specify the parameter settings of the image capturing device when used for taking the image and all other properties of the images. For example, for an MRI image, the reference set of attributes may include scanning sequence, slice thickness, imaging frequency, pixel bandwidth, etc. Since many medical images have hundreds of attributes and each attribute is important in determining the appearance of the image, it is essential that the reference set is as comprehensive as it possibly can be.

In one embodiment, the reference attributes are predetermined by the clinicians overseeing the trial and manually entered into a database for future reference. In another embodiment, reference attributes are obtained from existing historic images. For example, in a clinical trial studying the effects of certain medicine on a patient having a tumor, the very first MRI in the record of the tumor taken before the patient's participation in the trial may be used to produce the reference set of attributes. The clinicians can then compare the MRIs of the tumor taken during the trial with the first MRI to see whether there have been any positive or negative changes in the tumor. However, not every visible change in the MRIs necessarily reflects a change of the tumor if they are taken using different parameters. For example, the tumor may appear to have grown where it really has not if the subsequent MRI is taken at a different slice thickness from the original MRI. To ensure that any change on the MRIs reflects actual physical changes of the tumor and is not as a result of different attributes of the images themselves, it is necessary for the clinicians to compare the attributes of the later MRIs with those of the first MRI before actually comparing the images.

In one embodiment, the first image may have to be scanned and digitized before its attributes can be determined from the image. In another embodiment, software tools are used to analyze the first image and extract attribute data from it. In yet another embodiment where the first image is already in an electronic file format as illustrated in FIG. 1, the attribute data may be more easily obtained by using customized software to locate and parse the header of the file. In yet another embodiment, some attributes are derived from a combination of other attributes stored in the electronic file. For example, an electronic image file may not contain attribute data on the size of the image. However, the image size attribute can be easily calculated by multiplying the number of pixels in the image and the size of each pixel, given that both the pixel number attribute and the pixel size attribute of the image are available directly from the header of the electronic file. In yet another embodiment, the attribute data of the first image may simply be defined. After extracting the attribute data from the image, the image and its attribute data are then stored in a file system or a database that can be easily queried for information.

Once the reference attributes are determined, either manually or from an existing historic image, clinicians can then perform quality control of a medical image taken subsequently by obtaining a set of corresponding attributes of the new image (“test image”) (step 202). In one embodiment, this step is similarly performed by software tools that are designed to analyze and extract information from the image. The software may also allow the image reader to manually supply attribute data not stored in the electronic file of the image. The extracted data may then be reformatted and stored in the same database where the reference image and attributes are kept. Each image and its attribute data are uniquely identified in the database. In various embodiments, the database may be a relational database or an object-oriented database.

Still referring to FIG. 2, the next step in the quality control process involves tabulating and comparing the attributes of the test image with the pre-determined reference attributes (step 204). The differences between the two sets of attributes are then highlighted and displayed on an output screen to be analyzed by the clinicians (step 206). If the reference set of attributes are obtained from a historic reference image, the reference image and the subsequent test image may also be displayed on the output screen so that the clinician is easily able to see how the differences in the images' attributes translate into visual differences of the images. In one embodiment, the output screen may be divided on multiple monitors, for example, with a first monitor displaying the reference image and attributes and a second monitor displaying the test images and attributes.

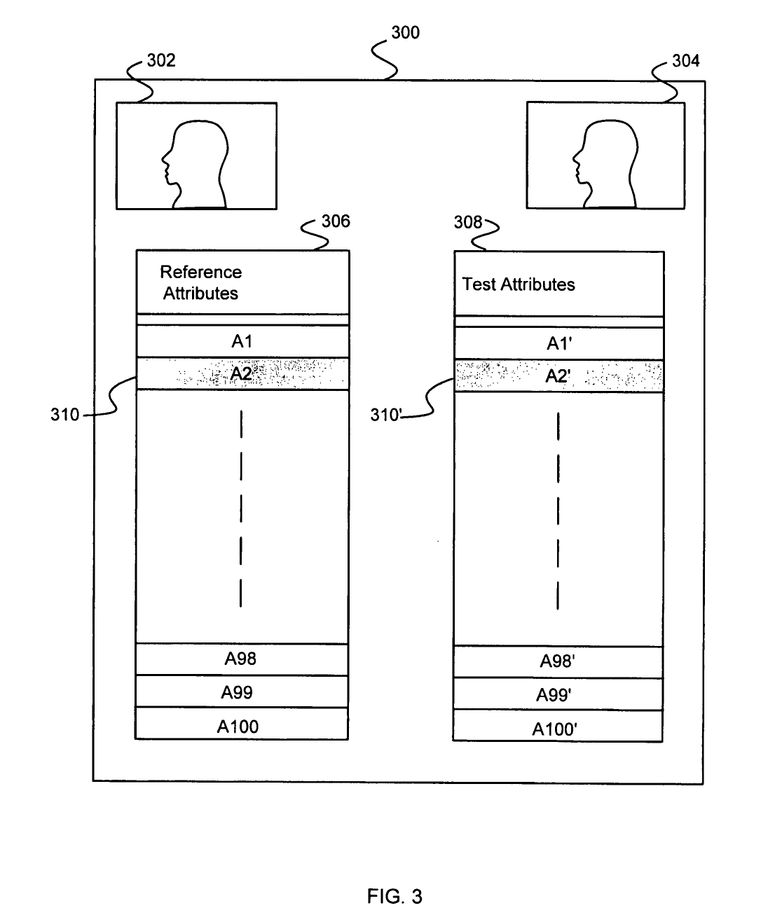

FIG. 3 illustrates an exemplary display layout 300 for comparing a test image 304 with a reference image 302, according to an embodiment of the invention. The reference image 302 and the test image 304 and their respective attributes 306, 308 are displayed side by side on a single output screen 300. As illustrated, the attributes 306, 308 are tabulated and sorted so that each reference attribute is displayed next to its corresponding attribute of the test image. If one of the attributes, A2′, 310′ associated with the test image 308 does not match its corresponding reference attribute, A2, 310, the attribute A2′ 310′ is highlighted in a different color on the output screen 300. An output that displays highlighted attributes indicates to the clinician that there may be a potential quality issue with the test image which may require the clinician to perform further analysis of the test image or reproduce the test image with attributes consistent with the reference attributes.

In another embodiment, each reference attribute is assigned a predetermined range of valid values. For example, the Slice Thickness attribute of an MRI may have a valid range of 2.5 mm to 3.5 mm, and the Number of Slices attribute may only be between 120 and 300. These ranges are usually stored with their corresponding reference attributes in the same database. When the reference attribute data is used to verify a test image, both the reference attributes and their associated value range are displayed on the output to be compared with the corresponding attributes and attribute values of the test image. In this embodiment, when the value of a particular attribute of the test image is not within the valid range of values pre-assigned to its corresponding reference attribute, the attribute of the test image is highlighted on the output to designate a potential problem with the quality of the test image.

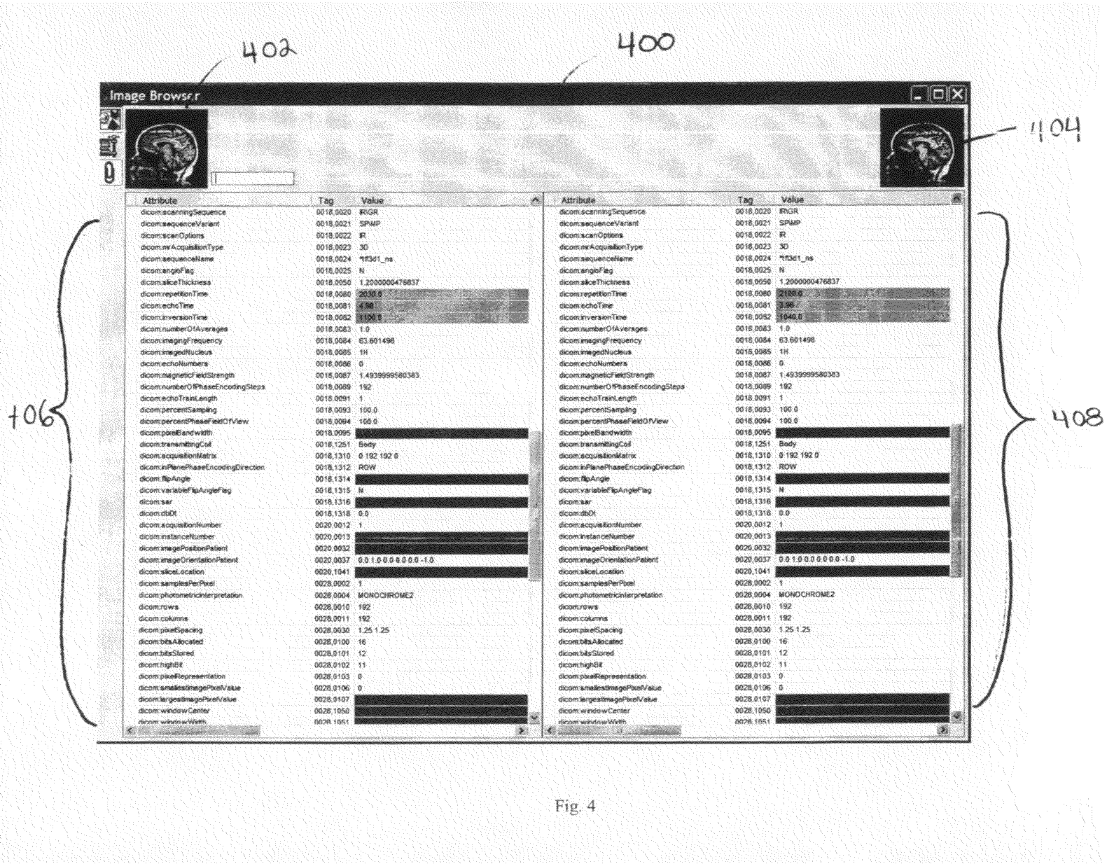

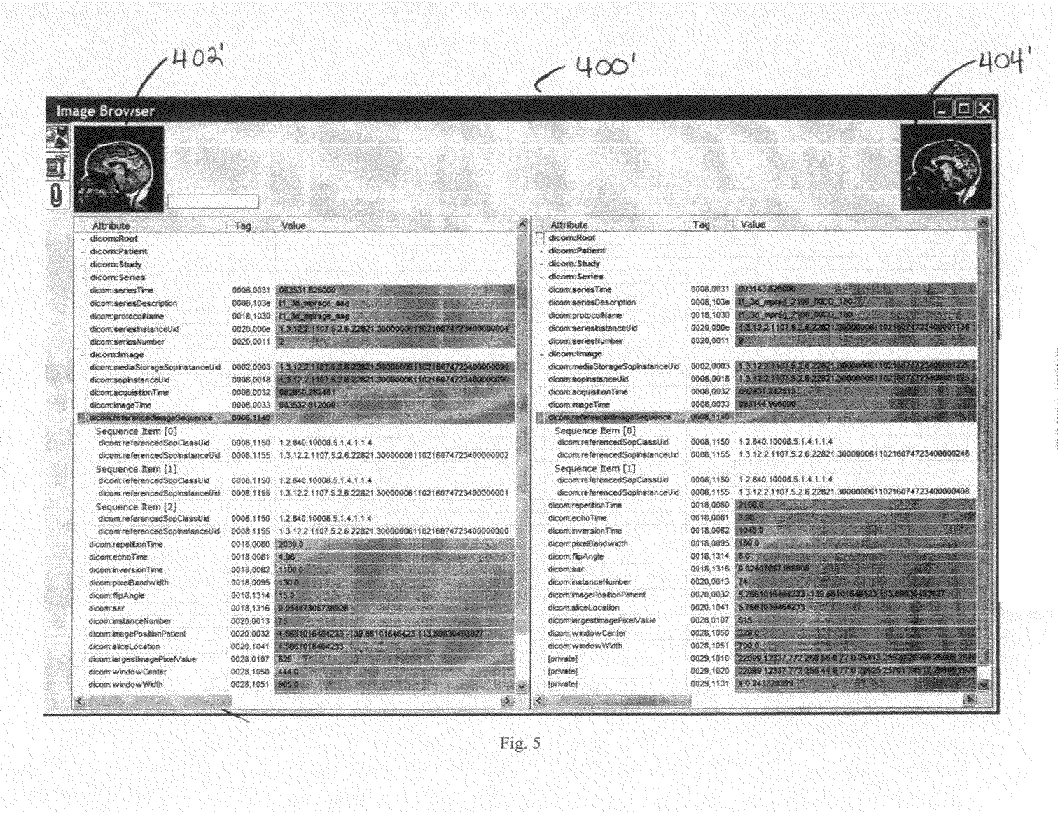

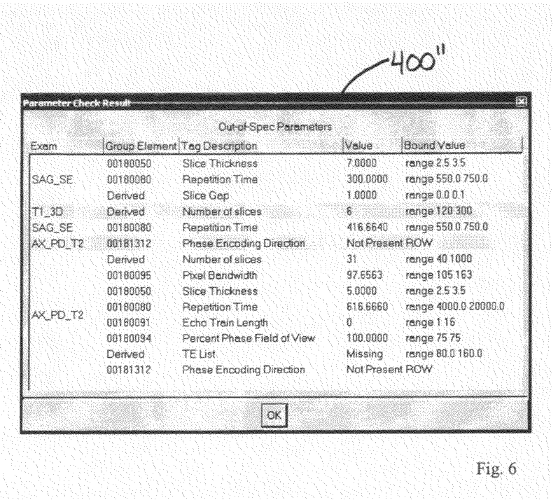

FIGS. 4, 5 and 6 illustrate other variations of output layouts denoting the differences between the attributes of the reference image and the test image. FIG. 4 is an example of an attribute display showing a side-by-side comparison of attributes from a reference image 402 and a test image 404 where matching attributes having different values are highlights. For example, the Repetition Time attributes in both attribute tables 406, 408 are highlighted because the reference image has a repetition rate of 2030.0 while the test image has a repetition rate of 2100.0. FIG. 5 illustrates a different example of an attribute display 400′ which also shows a side-by-side display of attributes from a reference image 402′ and a test image 404′. In this format, however, the matching attributes have been masked on the screen, leaving displayed only those attributes that do not meet specification. In yet another embodiment, as illustrated by FIG. 6, the output screen 400″ only lists those attributes of the test image having a value which is outside of their predetermined valid range. For example, the attribute Slice Thickness has a value of 7 which is out side of the range 2.5-3.5 and thus it is listed on the display. This format provides a simple alternative way of presenting the key information so that an image reader can determine whether of not the test image is of acceptable quality. Other display format includes displaying the reference attributes as an annotation upon the reference image and the attributes of the test image as an annotation upon the test image. As illustrated FIGS. 4, 5 and 6, the display format may be customized to satisfy the needs of the different image readers or based on a particular type of image. The software application controlling the output may have addition functionalities which allow a user to switch between different output formats and input comments regarding a particular attribute.

The key steps of the claimed invention as described above may be carried out by hardware combinations that vary from one clinical trial setting to another. In one embodiment, the present invention discloses a system for performing quality control on medical images. The system includes a scanner and/or a camera as input devices to capture the reference and test images. The system further includes a computer having a processor and installed with the required software that allows a user to designate images as reference or test images and to analyze and extract attribute data from the images. As previously mentioned, a data storage component, such as a database, is typically used to store the images and attributes data. The system also includes a display for displaying and comparing images and an indicator for denoting attributes having out-of-range values.

Although the embodiments disclosed above are discussed in the scope of providing solutions in response to a request for a medical service, one of ordinary skill in the art can easily adopt the same methods and systems for the providing of other type of services. Variations, modifications, and other implementations of what is described herein will occur to those of ordinary skill in the art without departing from the spirit and scope of the invention as claimed. Accordingly, the invention is to be defined not by the preceding illustrative description but instead by the spirit and scope of the following claims.

What is claimed is:

1. A method for performing quality control on medical images in a clinical trial setting comprising the steps of:
designating an image as reference image;
obtaining attribute data from said reference image as reference attribute data;
storing said reference image and said reference attribute data;
subsequently taking a second image;
obtaining attribute data from said second image as second attribute data;
comparing said second image with said reference image on a single output screen; and
denoting on said single output screen said second attribute data associated with said second image which differs from said reference data associated with said reference image.

2. The method of claim 1 wherein said single output screen is displayed on a plurality of monitors.

3. The method of claim 1 wherein said reference image and said reference attribute data are stored in a single electronic file.

4. The method of claim 1 wherein said second image and said second attribute data are stored in a single electronic file.

5. The method of claim 1 wherein the step of obtaining attribute data from said reference image as reference attribute data further comprising the step of deriving said attribute data from other attribute data associated with said reference image.

6. The method of claim 1 wherein the step of obtaining attribute data from said second image as second attribute data further comprising the step of deriving said attribute data from other attribute data associated with said second image.

7. The method of claim 1 wherein said second image is from a set of medical images.

8. A method for comparing a first medical image and a second medical image in a clinical trial setting comprising the steps of:
obtaining a first set of attributes from said first medical image;
obtaining a second set of attributes from said second medical image; and
displaying said first set of attributes and said second set of attributes on a single output screen.

9. The method of claim 8 wherein said single output screen is displayed on a plurality of monitors.

10. The method of claim 8 further comprising the steps of:
comparing said first set of attributes with said second set of attributes; and
denoting attributes from said second set of attributes which differs from any attributes of said first set of attributes.

11. The method of claim 10 the denoting step further comprising the step of displaying on a display said attribute from said second set of attributes which differs from a corresponding attribute in said first set of attributes.

12. The method of claim 10 wherein the comparing step further comprising the step of displaying on a display said first medical image with said first set of attributes and said second image with said second set of attributes.

13. The method of claim 10 wherein the step of denoting further comprising highlighting said attributes from said second set of attributes which differ from corresponding attributes in said first set of attributes.

14. The method of claim 8 wherein the first set of attributes is displayed as an annotation upon the first medical image and the second set of attributes is displayed as an annotation upon the second medical image.

15. The method of claim 8 wherein said first and second medical images each is an image from a set of medical images.

16. The method of claim 15 wherein said set of medical images further comprises a temporal series.

17. The method of claim 15 wherein said set of medical images further comprises a spatial series.

18. The method of claim 8 wherein said second medical image and said second set of attributes are stored in a single electronic file.

19. A method of performing quality control on a medical image in a clinical trial setting comprising the steps of:
defining a reference set of attributes, each reference attribute having a pre-determined range of valid values;
obtaining a first set of attributes associated with said medical image;
obtaining the value of each attribute in said first set of attributes;
comparing each attribute of said first set of attributes with a corresponding attribute of said reference set of attributes; and
denoting attributes of said first set of attributes having a value outside of said valid range of values assigned to a corresponding attribute in said reference set of attributes.

20. The method of claim 19 wherein said reference set of attributes is from a historical image.

21. The method of claim 19 wherein each attribute in the reference set of attributes is associated with a unique identification.

22. The method of claim 19 wherein each attribute in the first set of attributes is associated with a unique identification.

23. A system for performing quality control on medical images in a clinical trial setting, said system comprising:
means for designating an image as reference image;
means for obtaining attribute data from said reference image as reference attribute data;
means for storing said reference image and said reference attribute data;
means for subsequently taking a second image;
means for obtaining second attribute data from said second image; and
means for displaying said reference attribute data and said second attribute data on a single screen

24. The system of claim 23 further comprising:
means for comparing said second image with said reference image on said single output screen; and
means for denoting said second attribute data associated with said second image which differs from said reference data associated with said reference image.

25. A system for performing quality control on medical images in a clinical trial setting, said system comprising:
a first input device for designating an image as reference image;
a second input device for obtaining attribute data from said reference image as reference attribute data;
data storage device for storing said reference image and said reference attribute data;
an imaging device for subsequently taking a second image;
a third input device for obtaining second attribute data from said second image;
a single display for comparing said second image with said reference image; and
a display indicator for denoting an attribute from said second attribute data associated with said second image which differs from a corresponding attribute from said reference data associated with said reference image.
